(19) United States
(12) Patent Application Publication
(10) Pub. No.: US 2025/0381891 A1
(43) Pub. Date: Dec. 18, 2025

(54) SEAT FOR VEHICLE

(71) Applicants: HYUNDAI MOTOR COMPANY, Seoul (KR); Kia Corporation, Seoul (KR); DAEWON Precision Industrial Co., LTD, Ansan-si (KR)

(72) Inventors: Deokgi HONG, Hwaseong-si (KR); Keun GWACK, Hwaseong-si (KR); Hyojin AHN, Ansan-si (KR)

(21) Appl. No.: 18/946,494

(22) Filed: Nov. 13, 2024

(30) Foreign Application Priority Data
Jun. 14, 2024 (KR) 10-2024-0077342

(51) Int. Cl. B60N 2/16

(52) U.S. Cl. CPC B60N 2/161; B60N 2/1645

(57) ABSTRACT

A vehicle seat includes a seat frame assembly that defines a skeleton of the vehicle seat, and a height adjusting mono-post module that supports a lower portion of the seat frame assembly and is height-adjustable to adjust a height of the seat frame assembly.

### CROSS-REFERENCE TO RELATED APPLICATION

This application claims priority to and the benefit of Korean Patent Application No. 10-2024-0077342, filed in the Korean Intellectual Property Office, on Jun. 14, 2024, the entire contents of which are incorporated herein by reference.

### TECHNICAL FIELD

The present disclosure relates to a seat for a vehicle. More particularly, the present disclosure relates to a seat for a mono-post vehicle having a height adjustment function.

### BACKGROUND

A passenger vehicle may include front seats for a driver and an assistant, and rear seats for additional passengers behind the front seats. Various convenience devices may be installed on the seats to enhance the comfort of the passengers.

For example, convenience devices mounted on the seat include a seat position adjustment device that adjusts the position of the seat by moving the seat forward and backward according to a body type of the passenger, a reclining device that adjusts the slope of the seat back, and a height device that adjusts the height of the seat.

In some cases of a conventional height adjustment device, a height adjustment angle may not be sufficiently secured, the device may not accommodate the various postures of passengers. In some cases, the device may adjust a height of the seat by a particular link, the durability of which may be deteriorated.

### SUMMARY

The present disclosure describes a vehicle seat having stability and durability by providing a simplified mono-post structure including a quarto-section link.

According to one aspect of the subject matter described in this application, a vehicle seat includes a seat frame assembly that defines a skeleton of the vehicle seat, and a height adjusting mono-post module that supports a lower portion of the seat frame assembly and is configured to adjust a height of the seat frame assembly.

Implementations according to this aspect can include one or more of the following features. For example, the height adjusting mono-post module can include an upper end base that is connected to the seat frame assembly and in contact with the lower portion of the seat frame assembly, the upper end base supporting the lower portion of the seat frame assembly, a lower end base that is disposed at and fixed to a vehicle body, the lower end base facing the upper end base, and a connection bracket that connects the upper end base and the lower end base to each other and is configured to rotate relative to the lower end base, where the upper end base is configured to move relative to the lower end base based on a rotation of the connection bracket to thereby adjust the height of the seat frame assembly.

In some implementations, the connection bracket can include a pair of front connection brackets that are disposed at a front portion of the height adjusting mono-post module and arranged laterally side by side, and a pair of rear connection brackets that are disposed at a rear portion of the height adjusting mono-post module and arranged laterally side by side. In some examples, each of the pair of front connection brackets can include an upper end portion rotatably connected to a front portion of the upper end base, and a lower end portion rotatably connected to a front portion of the lower end base.

In some implementations, the height adjusting mono-post module further can include a front connection bracket shaft that extends in a left-right direction and connects the upper end portions of the pair of front connection brackets to each other, where the upper end base defines a front opening at the front portion of the upper end base, and the front connection bracket shaft is inserted to the front opening of the upper end base.

In some implementations, each of the pair of rear connection brackets can include an upper end portion rotatably connected to a rear portion of the upper end base, and a lower end portion rotatably connected to a rear portion of the lower end base. In some examples, the height adjusting mono-post module further can include a rear connection bracket shaft that extends in a left-right direction and connects the upper end portions of the rear connection bracket to each other, where the upper end base defines a rear opening at the rear portion of the upper end base, and the rear connection bracket shaft is inserted to the rear opening of the upper end base.

In some implementations, the height adjusting mono-post module further can include an angle adjuster that is disposed between the lower end portion of one of the pair of rear connection brackets and the rear portion of the lower end base, the angle adjuster being in contact with the lower end portion of the one of the pair of rear connection brackets and configured to adjust the height of the seat frame assembly by rotating the pair of rear connection brackets.

In some implementations, the height adjusting mono-post module further can include a pair of angle adjusters that face each other and are disposed at the lower end portions of the pair of rear connection brackets, respectively, and a synchronization rod that extends in the left-right direction and connects the pair of angle adjusters to each other, where the pair of angle adjusters are connected to each other at a position between an inner rear end of one of the pair of rear connection brackets and an outer rear end of the lower end base.

In some implementations, each of the pair of angle adjusters is fixed to the synchronization rod and configured to rotate together with the synchronization rod based on a rotation of the synchronization rod. In some examples, the height adjusting mono-post module further can include an angle adjustment motor configured to rotate the synchronization rod. In some examples, the angle adjustment motor is fixed to the rear portion of the lower end base and configured to provide torque to the synchronization rod.

In some implementations, each of the pair of rear connection brackets can include (i) a front end connected to the upper end base and (ii) a rear end connected to one of the pair of angle adjusters, where the synchronization rod and the pair of angle adjusters are configured to be rotated based on the angle adjustment motor being driven. The pair of angle adjusters can be configured to rotate the rear ends of the pair of rear connection brackets based on the angle adjustment motor being driven to thereby adjust a height of the upper end base by rotating the front ends of the pair of rear connection brackets.

In some implementations, each of the pair of front connection brackets is configured to rotate based on a rotation of one of the pair of rear connection brackets.

In some implementations, seat gaps and movement can be suppressed by simplifying the height adjustment structure of a mono-post vehicle seat.

In some implementations, the collision strength can be satisfied by applying a high-strength recliner structure to the link hinge portion.

Further, an operation sensibility can be provided and marketability can be increased.

### BRIEF DESCRIPTION OF THE DRAWINGS

FIG. 1 is a perspective view showing an example of a vehicle seat.

FIG. 2 is a side view of the vehicle seat.

FIG. 3 is a sideview showing an example of a height adjusting mono-post module of the vehicle seat.

FIG. 4 is a perspective view showing an example of a connection structure of a rear connection bracket of the height adjusting mono-post module of the vehicle seat.

### DETAILED DESCRIPTION

Hereinafter, one or more implementations of the present disclosure will be described in detail with reference to the attached drawings and thus a person having ordinary skill in the art to which the present disclosure pertains can easily implement the present disclosure. The present disclosure can be implemented in many different forms and is not limited to the implementations described herein.

The drawings are schematic and not drawn to scale. Relative dimensions and ratios of parts in the drawings are shown exaggerated or reduced in size for clarity and convenience in the drawings, and any dimensions are illustrative only and not limiting. In addition, the same reference numerals are used to denote similar features in the same structure, element or parts appearing in two or more drawings.

An implementation is an example representation. As a result, numerous variations of the diagram are expected. Therefore, implementation is not limited to a particular form of the illustrated region, but also includes, for example, deformation of the form by manufacturing.

Hereinafter, with reference to the attached drawing, a structure of a vehicle seat 100 will be described in detail.

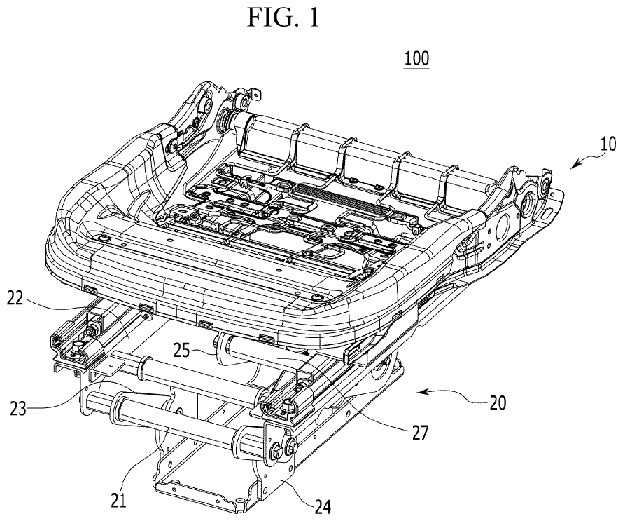

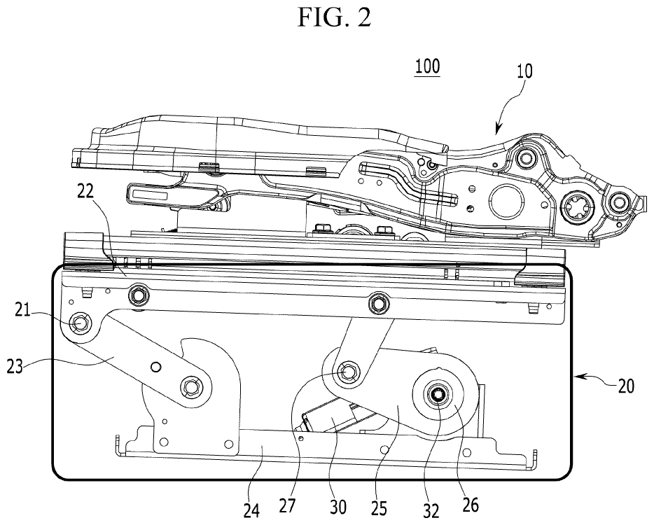

FIG. 1 is a perspective view of a vehicle seat, and FIG. 2 is a side view of the vehicle seat.

Referring to FIG. 1 and FIG. 2, in some implementations, the vehicle seat 100 can include a seat frame assembly 10 and a height-adjusting mono-post module 20. The seat frame assembly 10 can define the skeleton of the vehicle's seat and can hinge-rotate in the vertical direction of the vehicle. The seat frame assembly 10 can include a floor portion arranged in the horizontal direction of the vehicle and a backrest portion that can be arranged in the horizontal direction and the vertical direction of the vehicle by hinge rotation in the vertical direction of the vehicle. In some examples, a cushion and the like can be attached to the bottom and backrest such that a user can sit and lean against them.

The bottom portion of the seat frame assembly 10 is connected to the height adjusting mono-post module 20 while being in contact therewith, and the entire seat frame assembly 10 can be adjusted in height in the vertical direction of the vehicle by the height adjusting function of the height adjusting mono-post module 20.

For example, the height adjusting mono-post module 20 supports a lower portion of the seat frame assembly 10 and is height-adjustable, thereby allowing the height of the seat frame assembly 10 to be adjusted. The height adjusting mono-post module 20 can be designed to maintain the seat in position during normal use of the vehicle and to prevent or reduce seat displacement in the event of an accident. For example, the height adjusting mono-post module 20 can be designed to account for the possibility of impact at any speed in the forward, backward, and lateral directions. In some examples, the height adjusting mono-post module 20 can serve as a single support (i.e., “mono-post”) that supports the vehicle seat on a vehicle body.

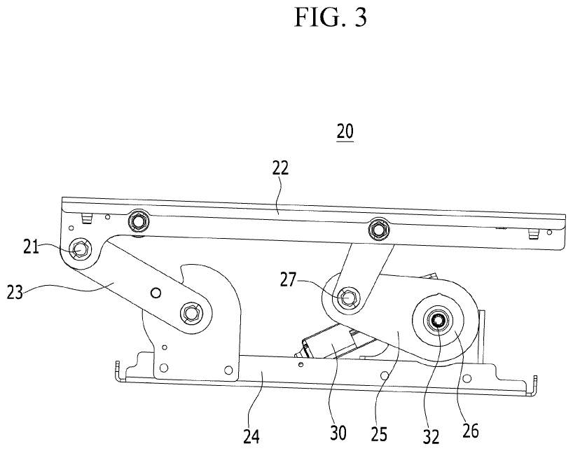

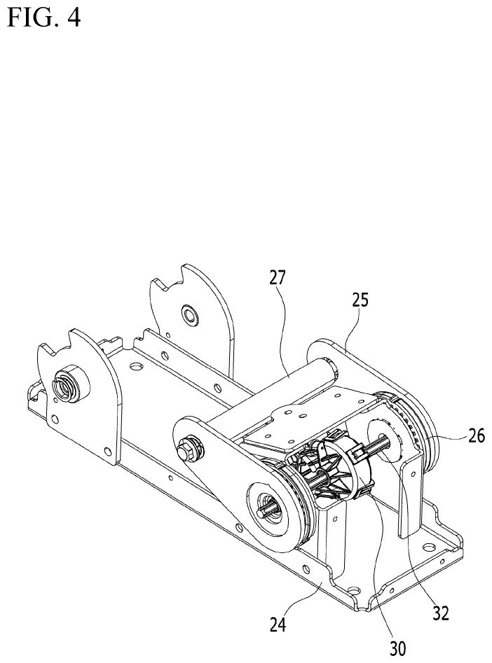

FIG. 3 is a sideview showing an example of a height adjusting mono-post module of the vehicle seat, and FIG. 4 is a perspective view of a connection structure of a rear connection bracket of the height adjusting mono-post module of the vehicle seat.

In some implementations, referring to FIG. 3 and FIG. 4, the height adjusting mono-post module 20 includes an upper end base 22, a lower end base 24, and connection brackets 23 and 25.

In some examples, the upper end base 22 can be in direct contact with a lower portion of the seat frame assembly 10 and support the seat frame assembly 10. In some examples, the upper end base 22 can be connected to the lower portion of the seat frame assembly 10 via intermediate connection parts. The lower end base 24 can be disposed to face the upper end base 22 and can be secured to an inner floor area of the vehicle body. The upper end base 22 and the lower end base 24 can be connected by the connection brackets 23 and 25.

The connection brackets 23 and 25 can include one or more front connection brackets 23 arranged at the front of the height adjusting mono-post module 20, and rear connection brackets 25 arranged side by side at the rear of the height adjusting mono-post module 20.

For instance, the front connection bracket 23 can be provided as a pair, arranged side by side in the left-right direction at the front of the vehicle, that is, at the front of the height adjusting mono-post module 20, and the rear connection bracket 25 can be provided as a pair, arranged side by side in the left-right direction at the rear of the vehicle, that is, at the rear of the height adjusting mono-post module 20.

The front connection bracket 23 and the rear connection bracket 25 are connected to the upper end base 22 and the lower end base 24 such that the front connection bracket 23 and the rear connection bracket 25 can hinge-rotate to change the relative distance between the upper end base 22 and the lower end base 24. With the lower end base 24 fixed to the vehicle body, the seat frame assembly 10 connected to the upper end base 22 rises as the upper end base 22 moves away from the lower end base 24 by the hinge rotation of the connection brackets 23 and 25. In some examples, when the upper end base 22 moves closer to the lower end base 24 by the hinge rotation of the connection brackets 23 and 25, the seat frame assembly 10 connected to the upper end base 22 is lowered.

The front connection bracket 23 can be formed in the form of a pair of bars having an upper end portion and a lower end portion, and the upper end portion is connected to the front portion of the upper end base 22 so as to be hinge-rotated and the lower end portion is connected to the front portion of the lower end base 24 so as to be hinge-rotated.

Upper end portions of the pair of front connection brackets 23 are connected to each other by a front connection bracket shaft 21, and the front connection bracket shaft 21 can be rotatably inserted into an opening formed in the front portion of the upper end base 22. The front connection bracket shaft 21 can be in the form of a rod extending in the left and right directions of the height adjusting mono-post module 20. In addition, lower end portions of the pair of front connection brackets 23 can be hinge-rotatably connected to the front portion of the lower end base 24, respectively.

In some implementations, the rear connection bracket 25 can be formed in the form of a pair of bars having an upper end portion and a lower end portion, and the upper end portion can be connected to the rear of the upper end base 22 to be hinge-rotated and the lower end portion can be connected to the rear of the lower end base 24 to be hinge-rotated.

The upper end portions of the pair of rear connection brackets 25 are connected to each other by a rear connection bracket shaft 27, and the rear connection bracket shaft 27 can be rotatably inserted into an opening formed in the rear portion of the upper end base 22. The rear connection bracket shaft 27 can be in the form of a rod extending in the left and right directions of the height adjusting mono-post module 20. In addition, the lower end portions of the pair of rear connection brackets 25 can each be hinge-rotatably connected to the rear of the lower end base 24.

In some implementations, an angle adjuster 26 can be disposed between the lower end portion of the rear connection bracket 25 and the rear portion of the lower end base 24. The lower end portion of the rear connection bracket 25 can be formed to corresponding to the size of the angle adjuster 26, and can be formed larger than the upper end portion of the rear connection bracket 25. The asymmetrical structure in which the lower end portion of the rear connection bracket 25 is larger than the upper end portion can improve the collision strength on the angle adjuster 26 side. In addition, the lower end portion of the rear connection bracket 25 can have an opening formed to expose the angle adjuster 26 from the outside.

The angle adjuster 26 is provided in contact with the lower end portion of the rear connection bracket 25 between the lower end portion of the rear connection bracket 25 and a rear portion of the lower end base 24, and can operate to adjust the height of the seat frame assembly 10 by rotating the rear connection bracket 25. The contact area between the angle adjuster 26 and the lower end portion of the rear connection bracket 25 can be formed by a combination of, for example, protrusion and groove to prevent slipping.

The angle adjuster 26 can be provided as a pair arranged to face each other at the lower end portion of the rear connection bracket 25, and the pair of angle adjusters 26 can be connected to each other between an inner side of the rear end of the rear connection bracket 25 and an outer side of the rear end of the lower end base 24 via a synchronization rod 32 extended in the left-right direction of the height adjusting mono-post module 20.

The angle adjuster 26 can be fixed to the synchronization rod 32, and the angle adjuster 26 can be rotated together when the synchronization rod 32 is rotated. In addition, the lower end portion of the rear connection bracket 25, which is in contact with the angle adjuster 26, rotates together such that the rear connection bracket 25 can hinge-rotate.

The axis rotation of the synchronization rod 32 can be performed by driving the angle adjustment motor 30. The angle adjustment motor 30 can be fixedly installed at the rear of the lower end base 24, and the synchronization rod 32 can be connected to a center of the angle adjustment motor 30. The angle adjustment motor 30 can be performed by a controller implemented as a processor that operates according to a predetermined program, and the predetermined program can be programmed according to the situation and needs of the passenger. In some examples, the controller can include an electric circuit.

When the angle adjustment motor 30 is driven by the controller, the synchronization rod 32 and the angle adjuster 26 are rotated, and the rotation of the angle adjuster 26 rotates the rear end of the rear connection bracket 25, which causes the hinge-rotation of the front end of the rear connection bracket 25, and thus the height of the upper end base 22 connected to the front end of the rear connection bracket 25 can be changed.

The front connection bracket 23 can be hinge-rotated in conjunction with the hinge rotation of the rear connection bracket 25, allowing the height of the upper end base 22 to be changed such that the height can be flat overall. That is, the height of the upper end base 22 can be increased or decreased by hinge-rotation of the front connection bracket 23 in the same direction as the hinge-rotation of the rear connection bracket 25.

In this way, seat gaps and movements can be suppressed by simplifying the height adjustment structure of a mono-post vehicle seat,

In addition, the collision strength can be satisfied by applying a high-strength recliner structure to the link hinge portion.

In addition, an operation sensibility can be provided and marketability can be increased.

While this disclosure has been described in connection with what is presently considered to be practical implementations, it is to be understood that the disclosure is not limited to the disclosed implementations. It is intended to cover various modifications and equivalent arrangements included within the spirit and scope of the appended claims.

What is claimed is:

1. A vehicle seat, comprising:
a seat frame assembly that defines a skeleton of the vehicle seat; and
a height adjusting mono-post module that supports a lower portion of the seat frame assembly and is configured to adjust a height of the seat frame assembly.

2. The vehicle seat of claim 1, wherein the height adjusting mono-post module comprises:
an upper end base that is connected to the seat frame assembly and in contact with the lower portion of the seat frame assembly, the upper end base supporting the lower portion of the seat frame assembly;
a lower end base that is disposed at and fixed to a vehicle body, the lower end base facing the upper end base; and
a connection bracket that connects the upper end base and the lower end base to each other and is configured to rotate relative to the lower end base, and
where the upper end base is configured to move relative to the lower end base based on a rotation of the connection bracket to thereby adjust the height of the seat frame assembly.

3. The vehicle seat of claim 2, wherein the connection bracket comprises:
a pair of front connection brackets that are disposed at a front portion of the height adjusting mono-post module and arranged laterally side by side; and
a pair of rear connection brackets that are disposed at a rear portion of the height adjusting mono-post module and arranged laterally side by side.

4. The vehicle seat of claim 3, wherein each of the pair of front connection brackets comprises:
an upper end portion rotatably connected to a front portion of the upper end base; and
a lower end portion rotatably connected to a front portion of the lower end base.

5. The vehicle seat of claim 4, wherein the height adjusting mono-post module further comprises:
a front connection bracket shaft that extends in a left-right direction and connects the upper end portions of the pair of front connection brackets to each other, and
wherein the upper end base defines a front opening at the front portion of the upper end base, and the front connection bracket shaft is inserted to the front opening of the upper end base.

6. The vehicle seat of claim 3, wherein each of the pair of rear connection brackets comprises:
an upper end portion rotatably connected to a rear portion of the upper end base; and
a lower end portion rotatably connected to a rear portion of the lower end base.

7. The vehicle seat of claim 6, wherein the height adjusting mono-post module further comprises:
a rear connection bracket shaft that extends in a left-right direction and connects the upper end portions of the rear connection brackets to each other, and
wherein the upper end base defines a rear opening at the rear portion of the upper end base, and the rear connection bracket shaft is inserted to the rear opening of the upper end base.

8. The vehicle seat of claim 7, wherein the height adjusting mono-post module further comprises:
an angle adjuster that is disposed between the lower end portion of one of the pair of rear connection brackets and the rear portion of the lower end base, the angle adjuster being in contact with the lower end portion of the one of the pair of rear connection brackets and configured to adjust the height of the seat frame assembly by rotating the pair of rear connection brackets.

9. The vehicle seat of claim 7, wherein the height adjusting mono-post module further comprises:
a pair of angle adjusters that face each other and are disposed at the lower end portions of the pair of rear connection brackets, respectively; and
a synchronization rod that extends in the left-right direction and connects the pair of angle adjusters to each other, and
wherein the pair of angle adjusters are connected to each other at a position between an inner rear end of one of the pair of rear connection brackets and an outer rear end of the lower end base.

10. The vehicle seat of claim 9, wherein each of the pair of angle adjusters is fixed to the synchronization rod and configured to rotate together with the synchronization rod based on a rotation of the synchronization rod.

11. The vehicle seat of claim 10, wherein the height adjusting mono-post module further comprises an angle adjustment motor configured to rotate the synchronization rod.

12. The vehicle seat of claim 11, wherein the angle adjustment motor is fixed to the rear portion of the lower end base and configured to provide torque to the synchronization rod.

13. The vehicle seat of claim 12, wherein each of the pair of rear connection brackets comprises (i) a front end connected to the upper end base and (ii) a rear end connected to one of the pair of angle adjusters,
wherein the synchronization rod and the pair of angle adjusters are configured to be rotated based on the angle adjustment motor being driven, and
wherein the pair of angle adjusters are configured to rotate the rear ends of the pair of rear connection brackets based on the angle adjustment motor being driven to thereby adjust a height of the upper end base by rotating the front ends of the pair of rear connection brackets.

14. The vehicle seat of claim 13, wherein each of the pair of front connection brackets is configured to rotate based on a rotation of one of the pair of rear connection brackets.
